(19) United States
(12) Patent Application Publication
(10) Pub. No.: US 2005/0267792 A1
(43) Pub. Date: Dec. 1, 2005

(54) Method and system for laboratory management

(76) Inventors: Sumit Mehrotra, Phoenix, AZ (US); Jon J. Jenkins, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/856,974

(22) Filed: May 28, 2004

(51) Int. Cl. G06F 17/60

(52) U.S. Cl. 705/9

(57) ABSTRACT

A method for managing the use of one or more laboratories is provided. Each of the laboratories comprises one or more workbenches used by a plurality of users. The method includes receiving one or more requests for use of one of the workbenches and assigning the requested workbenches based on predetermined criteria. The method further comprises receiving project data regarding a project being conducted on the workbench, the project data including comments entered by the user of the workbench, and storing the project data in a database.

### TECHNICAL FIELD OF THE INVENTION

This invention relates to the field of resource management and, more specifically to a method and system for laboratory management.

### BACKGROUND OF THE INVENTION

Businesses often have resources that are shared by many different users. Because of the expense of providing these resources, as well as the demand for the resources, it is important that the resources are fully utilized. For example, a company may have multiple laboratories available for use by engineers. Currently, these laboratories are scheduled in a haphazard manner. Additionally, results that are discovered in a laboratory environment are typically stored in a user's handwritten laboratory notebook. This makes it difficult to both share data, especially between users in different cities or countries, and it is difficult to search handwritten laboratory notebooks for old information. Issues like these leads to inefficient tracking of facility usage and maintenance.

### SUMMARY OF THE INVENTION

In one embodiment of the present invention, a method for managing the use of one or more laboratories is disclosed. Each of the laboratories comprises one or more workbenches used by a plurality of users. The method includes receiving one or more requests for use of one of the workbenches and assigning the requested workbenches based on predetermined criteria. The method further comprises receiving project data regarding a project being conducted on the workbench, the project data including comments entered by the user of the workbench, and storing the project data in a database.

In another embodiment of the present invention, a system for managing the use of one or more laboratories is disclosed. Each laboratory comprises one or more workbenches used by a plurality of users. The work benches include a server operable to receive one or more requests for use of one of the workbenches, assign the requested workbenches based on project task priority and receive project data regarding a project being conducted on the workbench; the project data including comments entered by the user of the workbench. The system further comprises a mass storage device operable to store the project data.

### BRIEF DESCRIPTION OF THE DRAWINGS

The present invention will hereinafter be described in conjunction with the following drawing figures, wherein like numerals denote like elements, and:

FIG. 1 illustrates a flowchart of the information flow in accordance with the present invention;

FIG. 2a-2b illustrate a computer system in accordance with the teachings of the present invention;

FIG. 3 is an exemplary login page in accordance with the teachings of the present invention;

FIG. 4 is an exemplary laboratory information page in accordance with the teachings of the present invention;

FIG. 5 is an exemplary project list page in accordance with the teachings of the present invention;

FIG. 6 is an exemplary bench configuration, health, and availability page in accordance with the teachings of the present invention;

FIG. 7 is an exemplary schedule page in accordance with the teachings of the present invention;

FIG. 8 is an exemplary request time page in accordance with the teachings of the present invention;

FIG. 9 is an exemplary laboratory request summary page in accordance with the teachings of the present invention;

FIG. 10 is an exemplary new session page in accordance with the teachings of the present invention;

FIG. 11 is an exemplary laboratory comment page in accordance with the teachings of the present invention;

FIG. 12 is an exemplary squawk page in accordance with the teachings of the present invention;

FIG. 13 is an exemplary session search page in accordance with the teachings of the present invention;

FIG. 14 is an exemplary session search result page in accordance with the teachings of the present invention;

FIG. 15 is an exemplary squawk search page in accordance with the teachings of the present invention;

FIG. 16 is an exemplary squawk search results page in accordance with the teachings of the present invention;

FIG. 17 is an exemplary squawk summary page in accordance with the teachings of the present invention;

FIG. 18 is an exemplary administrative submenu in accordance with the teachings of the present invention;

FIG. 19 is an exemplary add location screen in accordance with the teachings of the present invention;

FIG. 20 is an exemplary edit location screen in accordance with the teachings of the present invention;

FIG. 21 is an exemplary user administration screen in accordance with the teachings of the present invention;

FIG. 22 is an exemplary add bench screen in accordance with the teachings of the present invention;

FIG. 23 is an exemplary edit/delete bench screen in accordance with the teachings of the present invention;

FIG. 24 is an exemplary edit bench screen in accordance with the teachings of the present invention;

FIG. 25 is an exemplary add project-project data screen in accordance with the teachings of the present invention;

FIG. 26 is an exemplary add project-laboratory data screen in accordance with the teachings of the present invention;

FIG. 27 is an exemplary add project-squawk data screen in accordance with the teachings of the present invention;

FIG. 28 is an exemplary add project-schedule screen in accordance with the teachings of the present invention; and

FIG. 29 is an exemplary add project-configuration data screen in accordance with the teachings of the present invention.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

It should be understood that the programs, processes, methods, etc. described herein are but an example of one implementation of the present invention and are not related or limited to any particular computer, apparatus or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read only memory.

In an exemplary embodiment, the laboratory management system provides for a variety of needs related to laboratory management. In an embodiment of the present invention, the laboratory management system manages the scheduling and use of multiple laboratories across an organization. Each laboratory can have a number of benches. A bench can be any facility that can be used for testing/validation of a product and can also be referred to as a workbench. Each bench can have one or more projects being tested or otherwise used or evaluated at that bench. Each project can comprises multiple work sessions performed by multiple users. In the present invention a bench will typically have a computer associated with it. The laboratory management system of the present invention provides for, among other things, laboratory scheduling, laboratory session data entry and tracking and laboratory problems (or “squawks”) reporting, tracking and disposition.

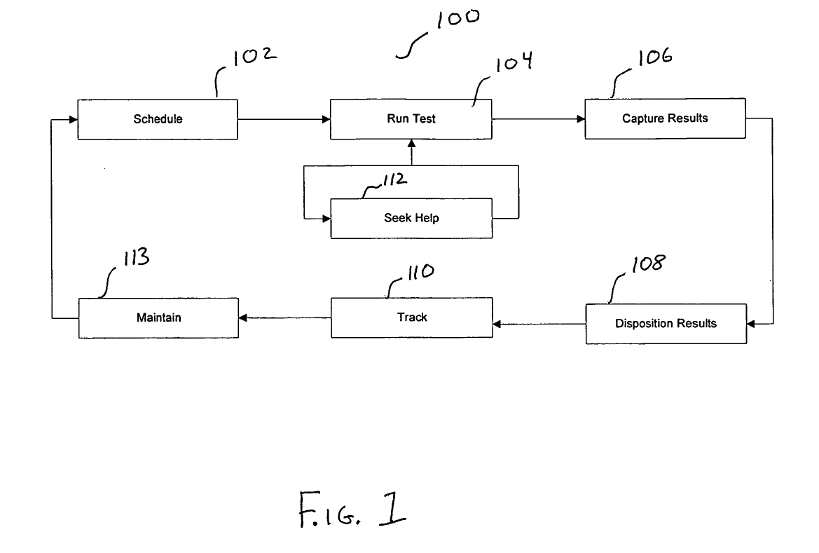

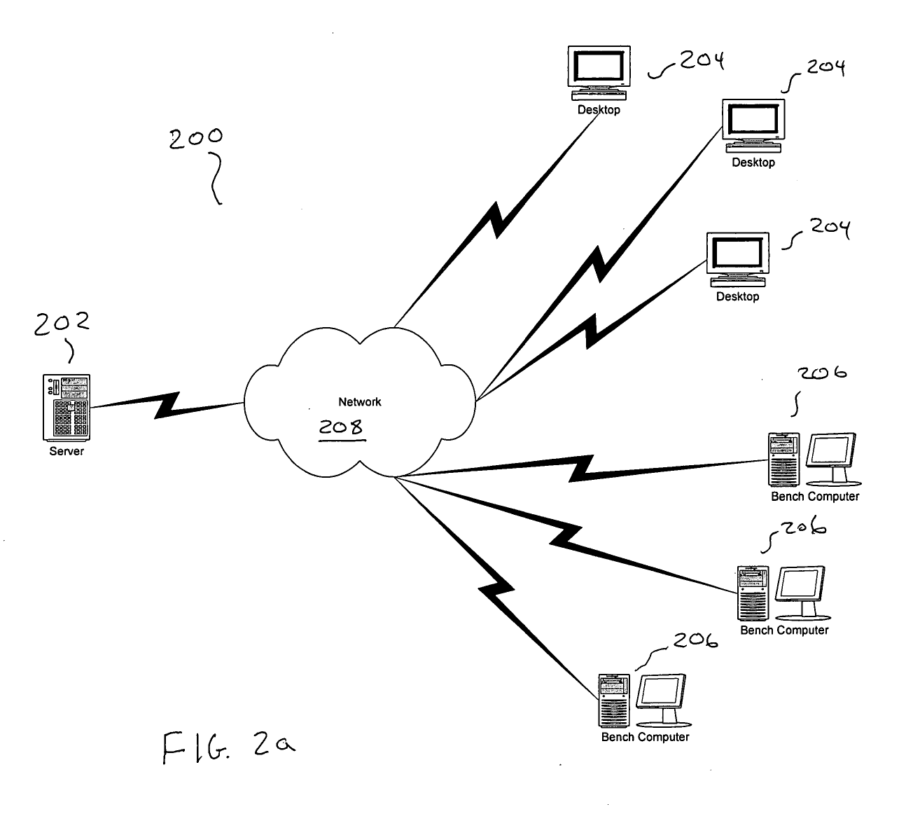

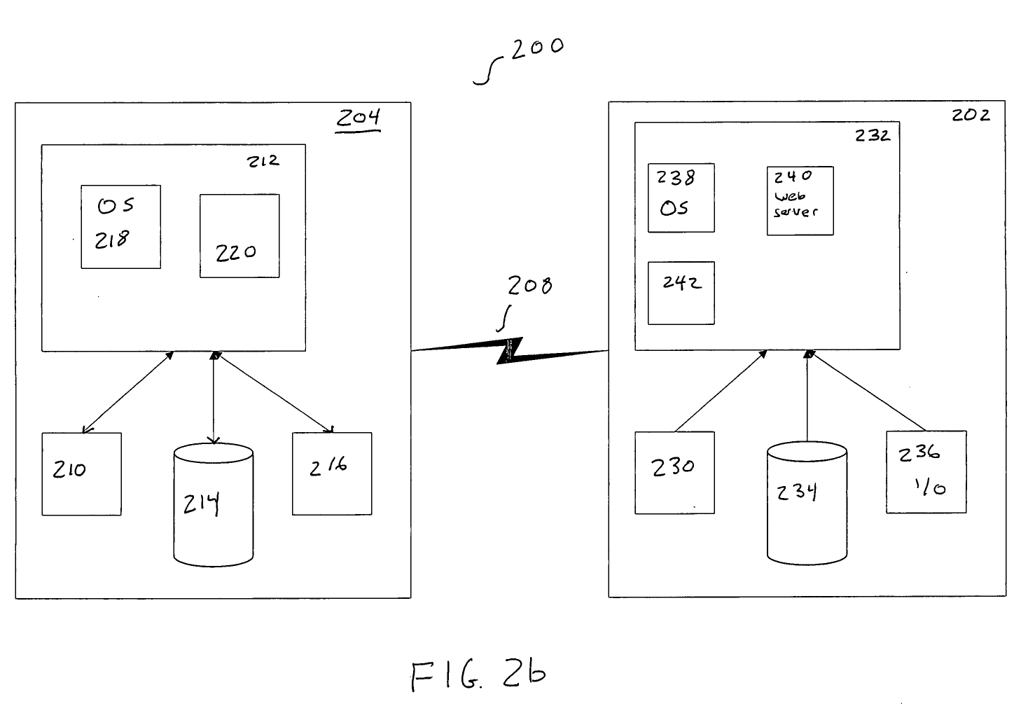

For example, FIGS. 1-2 illustrate an asset management system 100, such as a laboratory management system. The management system 100 comprises multiple modules, with each module performing a management function. In one embodiment, the management system comprises a scheduling module 102 where the use of and access to various resources, such as a laboratory, testing equipment and the like are scheduled. Scheduling module 102 allows multiple users to request times to use the laboratory and assigns the usage based on predetermined criteria. Additionally, scheduling module 102 allows users to see what laboratories and benches are scheduled and when they are scheduled.

The management system 100 further comprises a test module 104 which can facilitate users in the conducting of tests, experiments or other inquiries in the laboratory or at a remote location.

The results of the test module 104 can be recorded and stored in a capture results module 106. These results can be captured electronically and can include multimedia data. Capture results module 106 allows the system to act like an electronic lab notebook.

The results that are captured by capture result module 106 can be shared with other users through a disposition module 108. The disposition module 108 can include sending emails concerning result or problems in a laboratory. Also, different reports based on the results can be generated.

A tracking module 110 tracks the progress of a test, of any problems associated with a laboratory or any other information. For example, problems with the laboratory can be logged and users responsible for resolving the problem can be notified.

A maintain module 113 stores tests and experimental results for future user. Projects can be archived when complete. Also, stored experiments and tests within currently existing projects can be searched and data recalled for review. A help module 112 can also be made available to provide help information for a user.

In one embodiment of the present invention and with reference to FIGS. 2a and 2b, the present invention can be implemented using client/server architecture such as computer network 200 including desktop client computers 204 and laboratory client computers 206 coupled, via a 208 network, to a server 202. Network 208 can be any network such as a local area network or a wide area network. Desktop client computer 204 and laboratory client computer 206 can couple to server 202 over the Internet or, preferably, a secure corporate Intranet.

Both desktop computer 204 and laboratory client computer 206 can be implemented using any type of computer. The main difference between desktop client computer 204 and laboratory client computer 206 is where the computers are physically located. Laboratory client computers 206 are located on individual benches in laboratories; while desktop client computers 204 are located at any other location such as an office. Therefore, the following discussion will reference desktop client computer 204 only, although the discussion is also applicable to laboratory client computer 206. Desktop client computer 204 can be any personal computer. The computer preferably includes a processor 210, a main memory 212, one or more mass storage device 214 such as a hard drive, floppy drive, optical storage devices, removable flash memory and the like and various input/output devices 216 such as a printer, a mouse and/or a keyboard, a monitor, and a modem. Desktop client computer 204 operates under the control of an operating system 218 such as, but not limited to, various versions of the WINDOWS OS, UNIX, LINUX and the like. Desktop client computer 204 may execute any number of available application programs including a web browser 220.

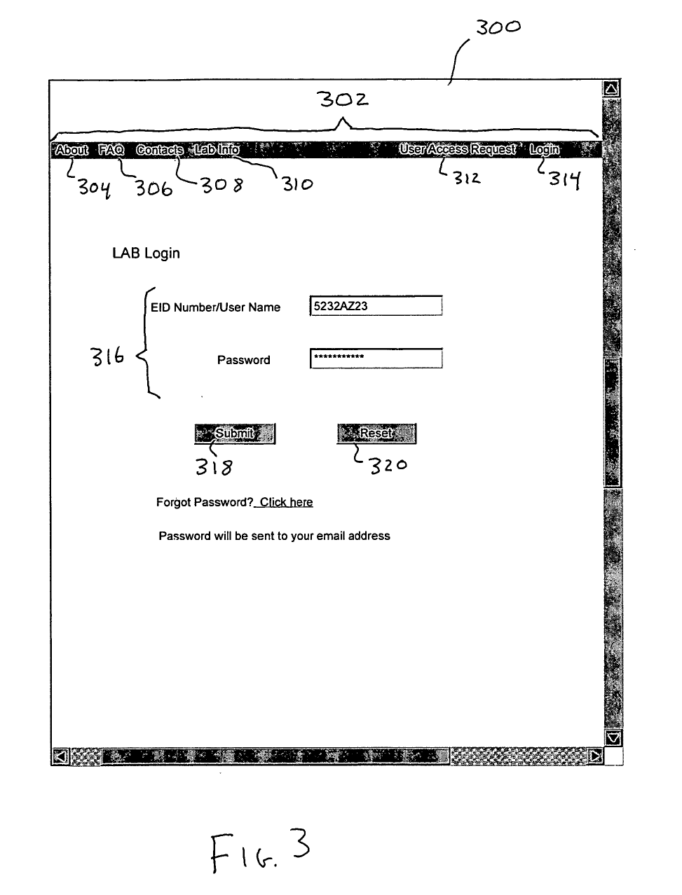

Server 202 can be any computer such as a personal computer, file server, workstation, minicomputer, mainframe, or any other computer capable of communicating and interconnecting with other computers. Server 202 will preferably include a processor 230, a main memory 232, one or more mass storage device 234 such as a hard drive, floppy drive, optical storage devices, removable flash memory and the like. Additionally, mass storage device 234 can provide storage for a database program. Server 202 further includes various input/output devices 236 such as a printer, a mouse and/or a keyboard, a monitor, and a modem. Server computer 202 operates under the control of an operating system 238 such as, but not limited to, various versions of the WINDOWS OS, UNIX, LINUX and the like. Server 202 can execute any number of available application programs including a web server 240 and various supporting applications including but not limited to a laboratory management application 242 in accordance with the teaching of the present invention. While server computer 202 is shown as a single computer in FIG. 2-3, the capabilities of server computer 202 can be divided amongst several different entities. For example, server 202 can be a web server, an application server and a database server, all interconnected.

Network 208 can be any interconnection found on any computer network such as a local area network (“LAN”), a wide area network (“WAN”), an intranet, such as a corporate intranet, the Internet or any other communications and data exchange system created by connecting two or more computers. The present invention can be illustrated and described with an implementation using an Intranet, however, it should be understood that the present invention is not limited to only implementations using an Intranet.

In one exemplary embodiment of the present invention, desktop client computer 204 and laboratory client computer 206 communicate with server 202 over the network 208 using web browser 220. Web browser 220 can be any program that can send and receive information from a web server, typically using a markup language, such as HTML, and a scripting language, such as JAVASCRIPT. Examples of suitable web browsers include MICROSOFT INTERNET EXPLORER and NETSCAPE NAVIGATOR.

Server 202 receives data from and sends data to desktop client computer 204 and laboratory client computer 206 using web server 240. Suitable web servers include the IPLANET WEB SERVER.

A user at either desktop client computer 204 or laboratory client computer 206 accesses the laboratory management application 242 running on server 202 using web browser 220. In one embodiment, to access the laboratory management application 242, the user enters an appropriate uniform resource locator (URL) into web browser 220. The URL is sent to the server 202 and the associated web page is retrieved and sent to the desktop client computer in HTML format. The HTML format is interpreted and processed by the web browser 220 in order to display the requested web page. Typically, web pages contain selectable icons that are associated with the URLs of related pages. A user selecting such an icon can navigate through the various web pages that comprise the laboratory management program. In the present invention the user can enter data into the appropriate areas of the web page and that data can then be sent to the server 202.

In use, an operator at either laboratory computer 206 or desktop computer 204 can, in one embodiment, access the laboratory management application 242, via a web browser 220 or similar program. The user can access any of the laboratory management program's 242 functionality from the desktop computer 204 or laboratory computer 206. For example, the user can schedule laboratory time. If the user is at a desktop or laboratory, the user can perform experiments and tests. The present invention allows the user to capture data, enter user commands, and note problems. Certain authorized users also have the ability to perform administrative duties.

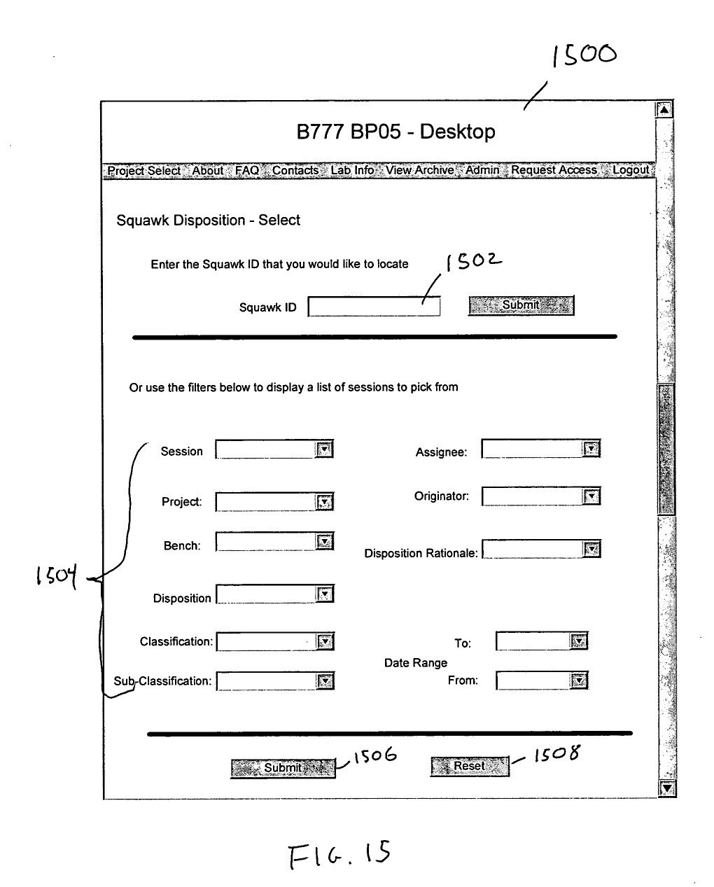

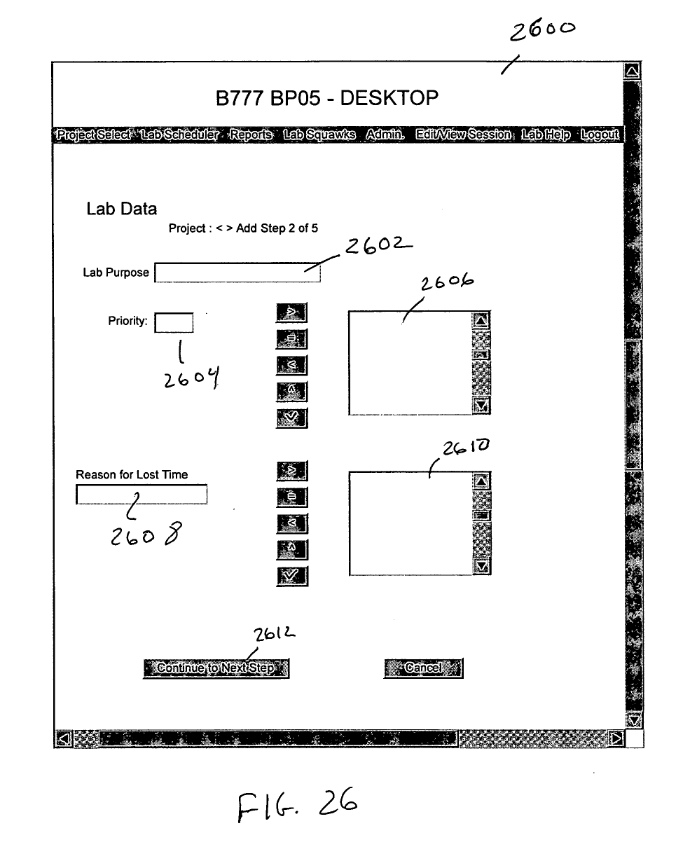

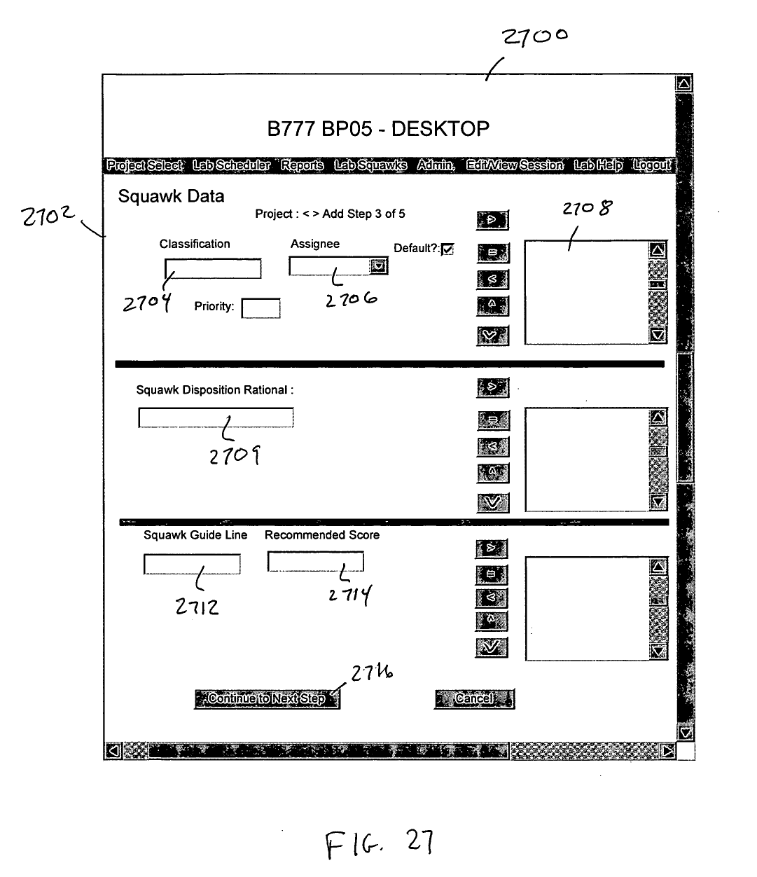

An exemplary embodiment of the laboratory management system in accordance with the teachings of the present invention is discussed in conjunction with FIGS. 3-29. The figures illustrate exemplary computer screens representing different functionality of the present invention. The functionality of the present invention is discussed in conjunction with the exemplary computer screens. However, the exemplary computer screens are shown as examples only and other formats and arrangements can be used that are within the scope and teachings of the present invention.

FIG. 3 is an exemplary welcome screen 300 in an exemplary embodiment of the present invention. In this exemplary embodiment, welcome screen 300 is the initial screen presented to a user when first using the laboratory management application 242. Welcome screen 300 includes a login menu section 302. In one embodiment, login menu section 302 includes an about selection 304, a frequently asked question selection 306, a contacts selection 308, a laboratory information selection 310, a user access request selection 312, and login selection 314. In a preferred embodiment, the login menu section 302 is provided in a graphical user interface, allowing a user to utilize an input device such as a computer mouse to select the selection. In one embodiment, when choosing any of the above selections 304-314 from menu section 302, a new web page or a pop-up of a web page can be provided.

About selection 304, when chosen, provides information regarding the capability and purpose of the invention. Frequently asked question selection 306, when chosen, in one embodiment, brings up a page of information including frequently asked questions about the laboratory management system and answers to those questions. Contacts selection 308, when chosen, displays the names and, preferably, the phone number, email address and any other contact information of persons involved with the operation and maintenance of the present invention.

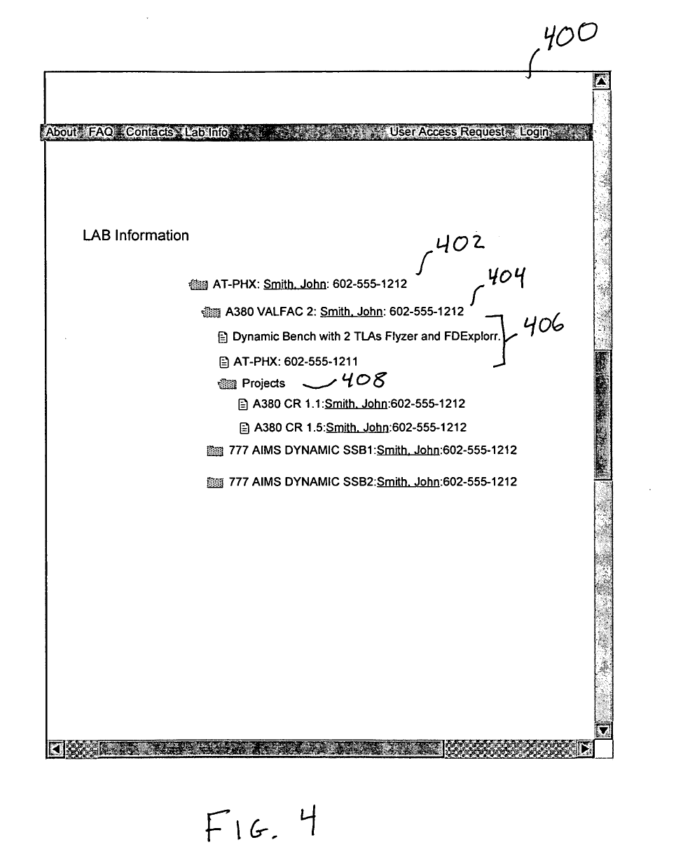

Laboratory information selection 310, when chosen, provides information about each laboratory at one or more locations and the benches within a laboratory for a given project. In one embodiment, when laboratory information selection 310 is chosen, a laboratory information screen, such as exemplary laboratory information screen 400 as seen in FIG. 4, is returned. Laboratory information screen 400 displays the information about the laboratory in a hierarchical format similar to a directory tree structure. In this embodiment, at the highest level, location names 402 are shown. In one embodiment, the location names 402 are the name of the location where one or more laboratories are located. Alternatively, the name of the laboratory, a combination of the location name and laboratory name or any other indicator of a laboratory or laboratory location can be used. When one of the location names 402 is chosen, the next branch of the tree is shown. In one embodiment, the next branch is a bench name branch 404. The bench name branch 404 lists all the bench names at that particular location.

Selection of one of the bench name branches 404 calls up bench summary 406. The bench summary 406 lists information about the bench including the administrative person in charge of the bench, the other projects using the bench, description of equipment available at the bench and the like. Note that in the present invention, each time a selection is made, more information is shown, similar to a tree structure used in computer mass storage directories. This provides an easy to navigate and understandable way to find information regarding different laboratories and the benches in the laboratories.

Also, shown under each bench name 404 is a project branch 408, listing all projects being done using the selected bench. The project branch 408 may include the name of the project, the contact responsible for the project and a contact phone number.

One advantage of providing laboratory information at the laboratory information page 400 is that this information is provided prior to logging on to the entire laboratory management system. This allows for administrative personnel or any other personnel to access non-proprietary information without having to be first granted access privileges or logging on to the system. Therefore, the present invention provides a simple and central location to examine laboratory and bench capabilities.

If user access request selection 312 is chosen, the user is presented with a registration screen that allows a user to request access to the rest of the laboratory management system. Since the laboratory management system supports many different projects, requesting access to the system typically includes indicating what project or projects the user wishes to access and for what reason. The decision to grant a user access is typically given to an overall administrator or a project administrator.

Selection of login selection 314 will call up the login page 300 if a page other than login page 300 is currently displayed. If login page 300 is currently displayed then login selection has no effect.

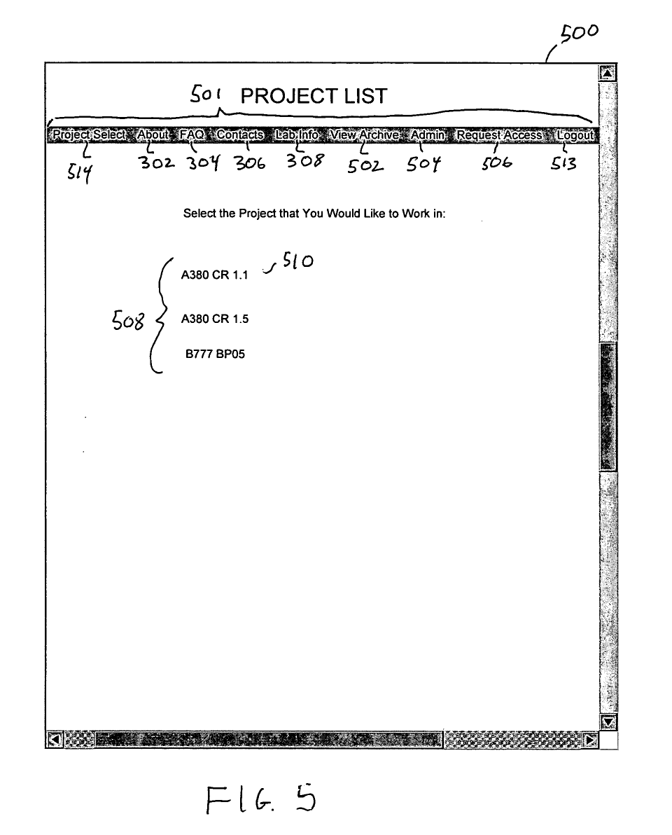

Once a user has requested and been granted access, the user can login to the laboratory by entering login information such as a user name and password or other identification into login section 316 of login page 300 and selecting the submit button 318. Selection of the reset button 320 clears all existing entries. Upon successful login, the project list screen 500, as seen in FIG. 5 is displayed.

The project list screen 500 includes a project list menu 501 comprising the about selection 302, the frequently asked questions selection 304, the contacts selection 306 and the laboratory information selection 308 from the login menu 302. These selections serve the same purposes as discussed previously. The project list menu 501 500 further includes a view archive selection 502, an administration selection 504, a request access selection 506, a project select page 514 and a logout selection 513.

View archive selection 502, when chosen, displays a search screen that allows users to either enter criteria or choose predefined criteria to search for an archived project. An archived project is a completed project whose data has been maintained for historical purposes. In one embodiment, archived projects can be searched based for using criteria such as the location of a laboratory, project name, bench used, date or other criteria.

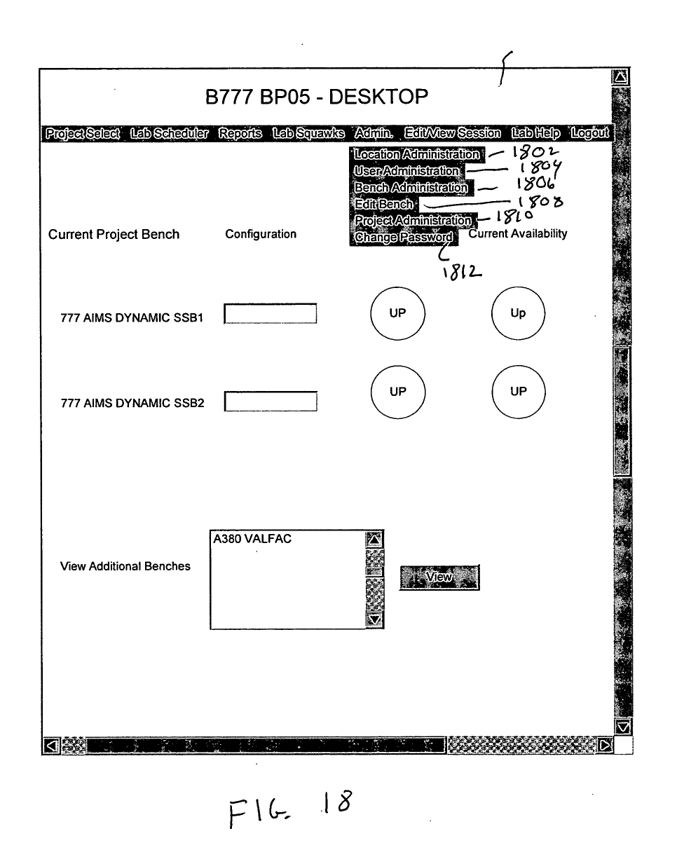

Administration selection 504, when chosen, brings up various administrative functions that allow a properly authenticated user to act as an administrator to manage users, edit data, change configuration of laboratories and benches and perform other functions. Administration section 504 can be discussed in further detail in conjunction with FIGS. 18-29.

Request access selection 506, when chosen, allows a user to request access to a project as a user or as an administrator. A user requesting access as a user typically enters information regarding the project to which the user desires access and reasons why the user desires access to the project. The request for access can be approved automatically based on some predefined criteria. In another embodiment, the access is granted after review by an administrator or other chosen individual. The user can also request administrative access. A request for administrative access is typically approved by an already existing administrator.

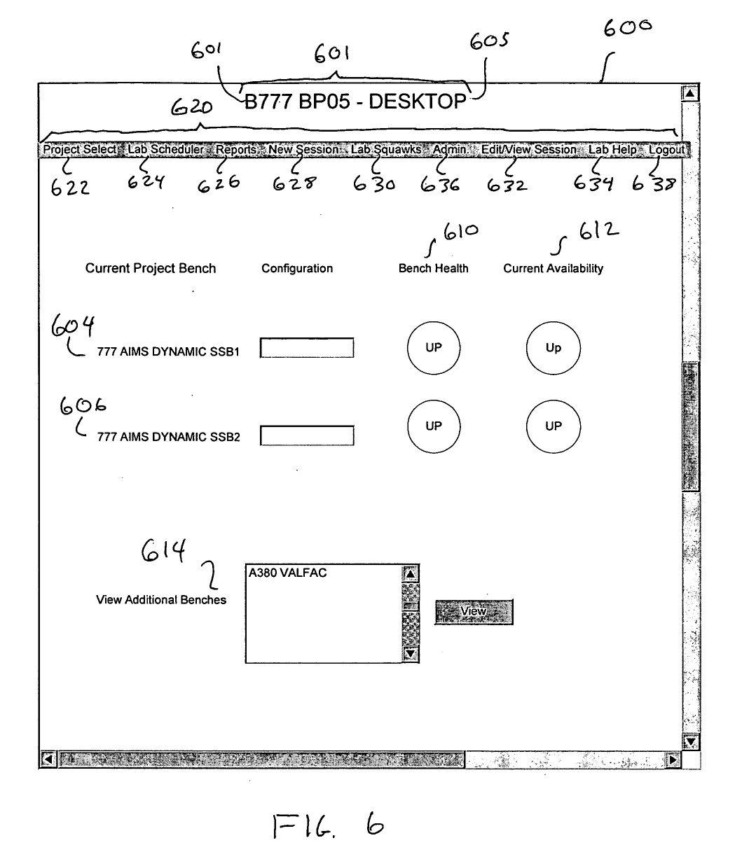

Project list screen 500 also provides a listing 508 of projects 510. The project listing preferably only lists projects to which the user has been granted access, although, in an alternative embodiment, all existing projects can be listed. In one embodiment, a user is able to select one of the projects 510 on the listing 508. The selection of one of the projects 510 will produce a bench configuration, health and availability page 600, as seen in FIG. 6, is displayed. The bench configuration, health and availability page 600 is customized to the project selected. The bench configuration, health and availability page 600 can include a header section 601 that lists the name of the project 603 and the name of the bench 605 being used. If the user is accessing the project information from a desktop then the name of the bench need not be displayed and the word desktop can be displayed instead.

The bench, configuration, health and availability page 600 displays the name of each bench assigned to the selected project 510. For example, in FIG. 6, a first bench 604 and a second bench 606 are shown. The bench, configuration, health and availability page 600 also shows a bench configuration 608, a bench health indicator 610 and a bench availability indicator 612. In one embodiment, bench configuration 608 comprises of the information about the individual components of the test environment available on the bench.

In one embodiment, bench health indicator 610 can provide a visual indication of the condition of the bench. The condition of the bench can be based on the number, severity, and/or resolution status of reported problems. Reported problems are also known as “squawks”. In one embodiment, the bench health indicator 610 is implemented as a colored shape, such as a circle. In this embodiment, a red shape can indicate the bench is “down” or unavailable for use, a yellow shape can indicate the bench is in a degraded status and a green shape can indicate the bench is up and available for use. In this embodiment, a subset of the squawks can be viewed when the user moved a mouse arrow or similar icon over the colored shape of the bench health indicator 610. Any other indicators of the health of a bench can also be used, such as textual indicators of bench health.

A bench availability indicator 612 provides an indicator if the bench is available for immediate use or not. In one embodiment, bench availability indicator 612 is a colored shape, with a green color indicating available bench or a red color indicating an occupied or unavailable bench. Other indicators of availability can also be used, such as textual indicators.

Bench configuration, health and availability page 600 further includes a view additional benches box 614, which allows the user to select other benches belonging to other projects to view. In one embodiment, only the benches belonging to projects the user has access to are shown in additional benches box 614. Selection of a bench allows information for the bench to be displayed in the form of the bench configuration, health and availability page 600.

Bench configuration, health and availability page 600 also includes a project home menu 620. Project home menu 620 includes the following selections; a project select selection 622, a laboratory schedule selection 624, a report selection 626, a new session selection 628, a laboratory squawk selection 630, an edit/view session selection 632, a laboratory help selection 634, an administration selection 636, and a logout selection 638.

The project select selection 622, when selected, typically displays the listing of all the projects to which the user has access although, in an alternative embodiment, all active projects can also be listed. When project select selection 622 is chosen, project list screen 500 of FIG. 5 is displayed.

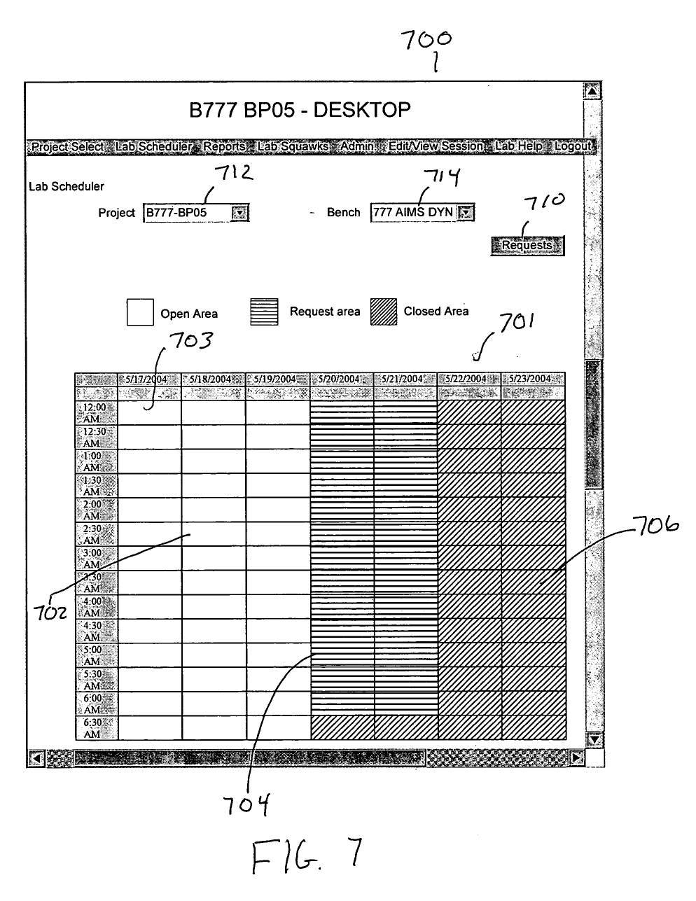

The laboratory schedule selection 624, when chosen, brings up a laboratory schedule page 700 as seen in FIG. 7. Laboratory schedule page 700 provides an interface comprising a calendar 701 listing times and days and having a plurality of time boxes 703 corresponding to a time interval and a date. Calendar 701 can also show one or more of the following: open time area 702, blocked time area 706 and/or request time area 704. In one embodiment, open time area 702, blocked time area 706 and request time area 704 are distinguished by color.

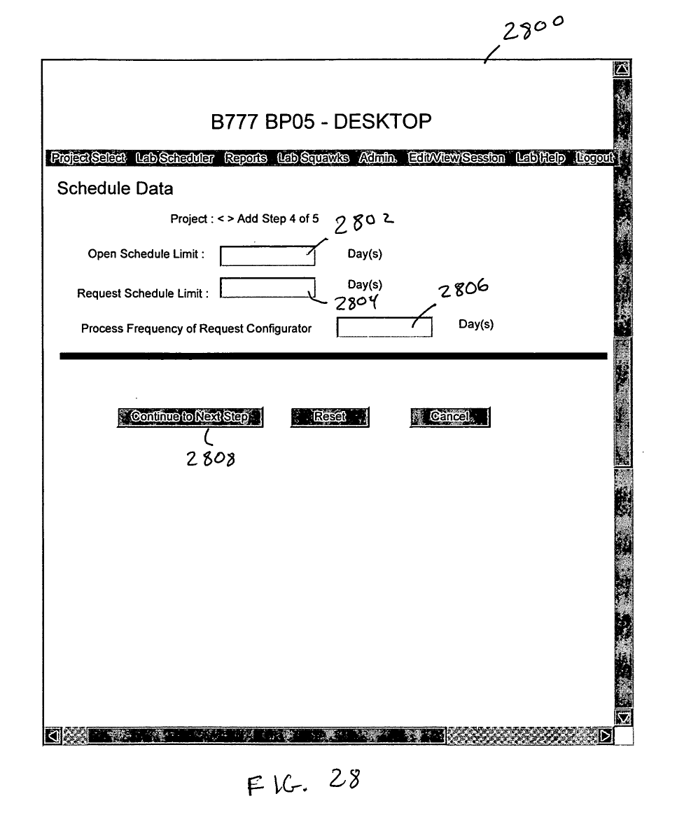

Open time area 702 is time that in which any approved user can schedule a laboratory session. In one embodiment, open time is time from the present time up to an open time limit, such as a number of days in the future. Open time area 702 can be selected by choosing one of the time boxes 703 within the open time area 702 that does not already have an entry indicating that the time has been reserved. The open time can be set by the administrative functions to any value depending upon the needs of the individual test facility. This is discussed in greater detail in conjunction with FIG. 28. Once one of the time boxes 703 in the open time area 702 is reserved, some indication can be displayed in the box, such as a project number.

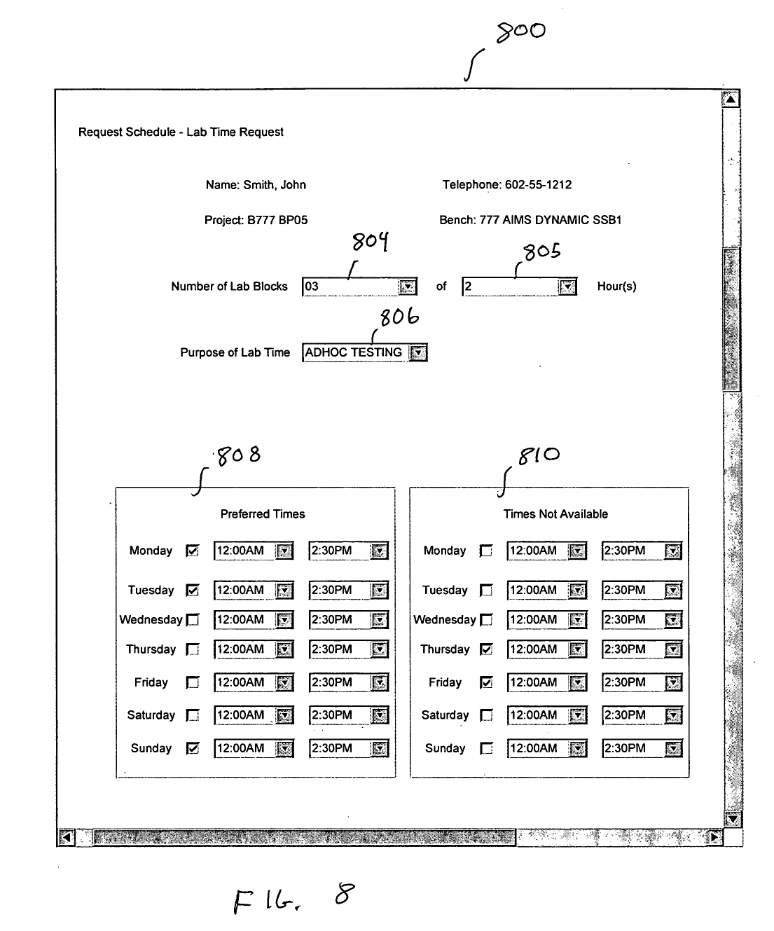

Request time area 704 provides a set of time that the user can request to use. In certain embodiments when multiple projects are using the same bench, there can be different request time areas 704 for each project. By selecting a day and/or time within request time area 704, a request page 800 as seen in FIG. 8 is displayed. Request page 800 provides for the entry of a requested length of time for use of a laboratory by entering a requested number of blocks in a laboratory block section 804 with the length of time of each block in block length sections 805. Also, in one embodiment, the purpose for the laboratory time is entered in a purpose box 806. The user can indicate preferred times and days for laboratory use in preferred time request section 808. Also, the user can enter non-available times in not available section 810. The preferred time request section 808 illustrates the use of check boxes to indicate preferred times. However, an alternative method of entering preferred times and days can be utilized. At some regular interval, such as once in every twenty four hour period, users can be assigned laboratory time based on their request and the requests of other users. In one embodiment, the assignment of laboratory time is done using an algorithm that uses inputs such as amount of time requested, project task priority and the like to determine which user is assigned a laboratory and at what time. Alternatively, requests can be manually reviewed by an administrator or similarly authorized user.

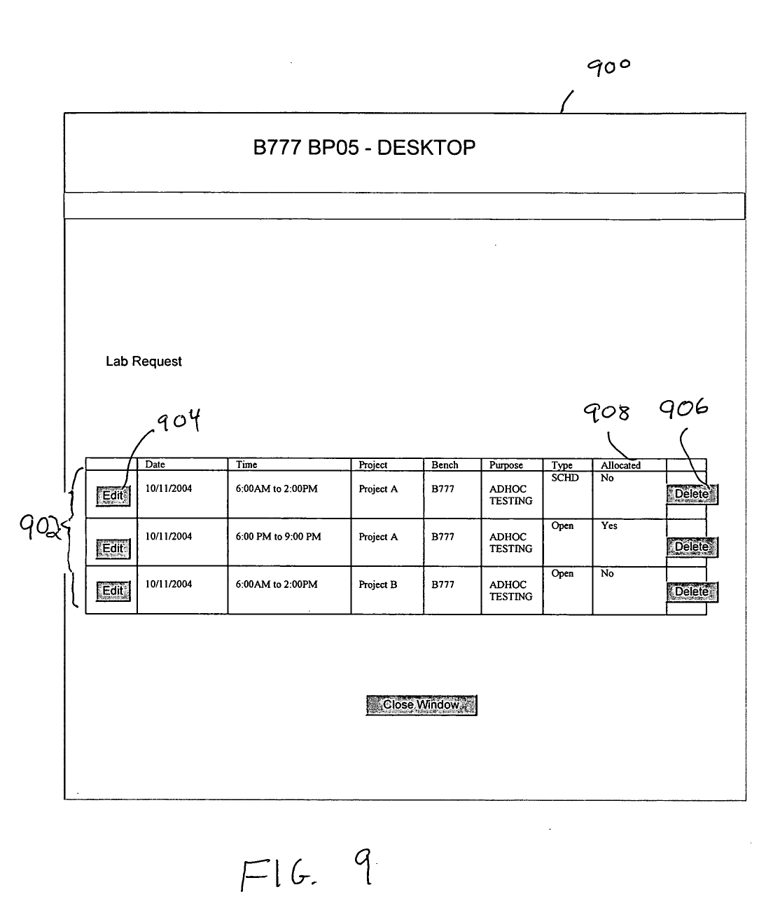

Laboratory schedule page 700 also provides a request link 710 to a laboratory request page 900 as seen in FIG. 9 that summarizes a user's laboratory requests. Laboratory request page 900 includes a list of laboratory requests 902. An edit button 904 is provided such that, when selected, a user can edit a laboratory request. A laboratory request can be deleted by selecting a delete button 906 associated with a given request 902. Also provided is an allocated column 908 that shows if the user's previous laboratory request was fulfilled. The request page can be closed by selecting the close window button 910. Referring back to laboratory schedule page 700, additionally, the user can select different projects and or benches to schedule time for by selecting the different projects or benches from project field 712 and bench field 714. Typically, only projects to which a user has access will be selectable.

Turning back to FIG. 6, selection of the report selection 626 provides the user with various tools to generate reports based on any combination of data gathered for all projects to which the user belongs.

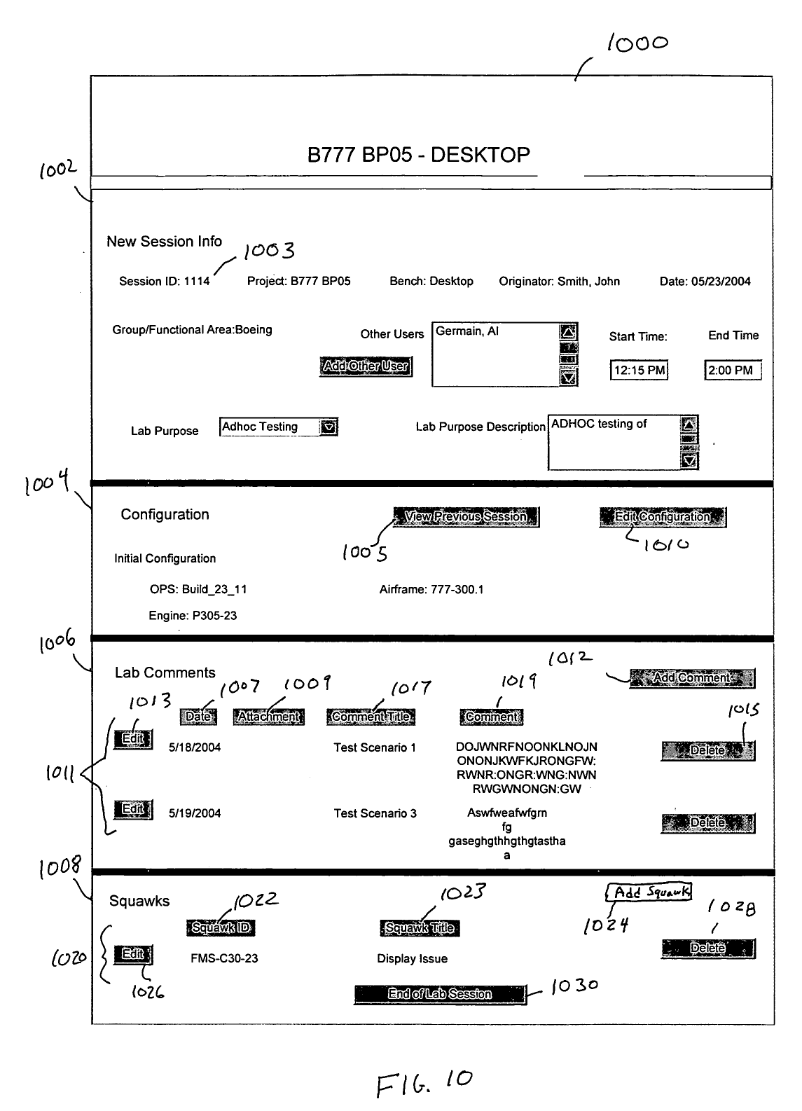

The new session selection 628, when chosen, brings up a new session page 1000 as seen in FIG. 10. The new session page 1000 can be used to enter comments from the user about the current test, experiment or other activity, capture data, problems and other content and the like. That is, the new session page 1000 is used similar to a laboratory notebook. In the exemplary embodiment shown in FIG. 10, new session page 1000 comprises a new session information section 1002, a configuration section 1004, a laboratory comment section 1006 and a squawk section 1008.

The new session information section 1002 displays information about the session, including the project and bench being used, the date of use and the user. Each time a new session is initiated, a session identification 1003 is generated. Other information can be entered such as the purpose of the laboratory session.

Configuration section 1004 displays information about the individual components of the test environment available for the test session as set by the administrative functions, discussed in greater detail below. The configuration data can be changed by selecting an edit button 1010. Previous configurations can be viewed by selecting view previous session button 1005.

Laboratory comment section 1006 allows the user to enter observations, results and any other information that the user wishes to store regarding the current experiment or inquiry. A summary section 1011 lists any previous comments. Summary section includes a date field 1007 showing the date the comment was entered, an attachment indicator field 1009 indicating if there is an attachment, a comment title field 1017 showing the title of the comment and a comment field 1019 showing the description of the comment.

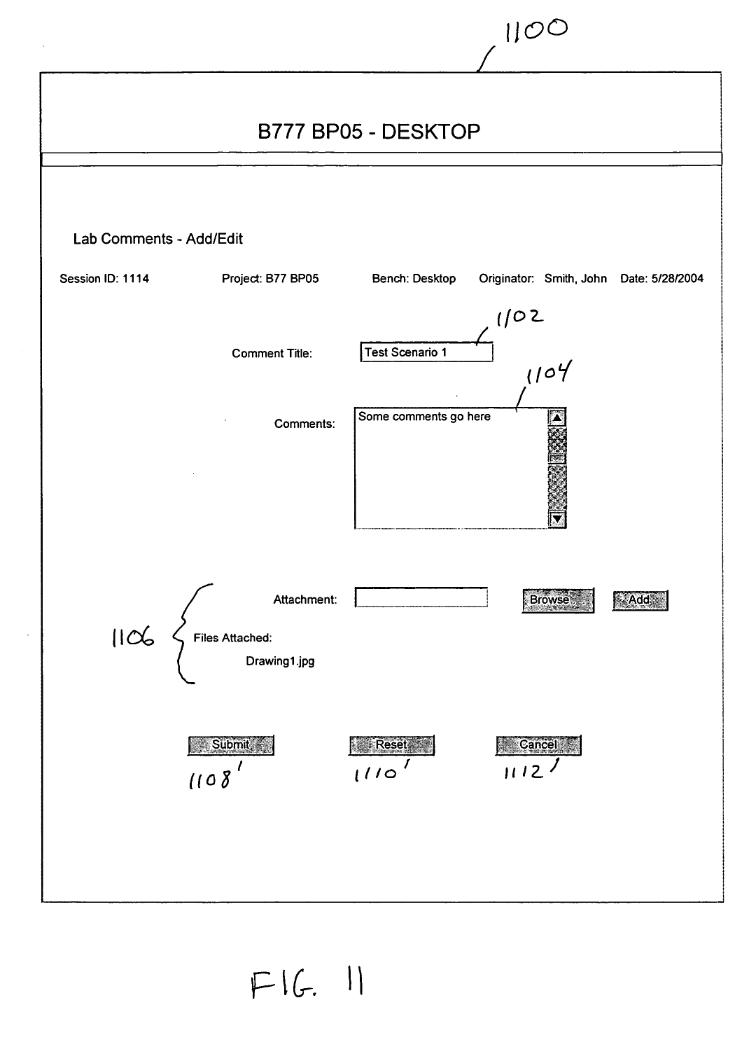

To enter a comment, the user selects an add comment button 1012. This brings up a laboratory comment page 1100 as seen in FIG. 11. The user can enter a comment title in title box 1102. The user can then enter any comment, observation, note or other textual information in the comment field 1104. In this manner, instead of entering text into a laboratory notebook, the text is entered into the comment field 1104. Files related to comments can be attached using the attachment section 1106. The comments can be automatically time and date stamped. When the comment is finished, a submit button 1108 can be selected, returning the user to the new session page 1000 shown in FIG. 10. All entries in the summary section can be cleared by selecting reset button 1110. Laboratory comment page 1100 can be exited without entering any new data by selecting cancel button 1112.

The summary section 1011 provides a listing of each comment, the time and date the comment was made, and provides ability to delete a given comment (by selecting delete button 1015) or edit a comment (by selecting edit button 1013). By providing the ability to store time and date stamped comments, the user produces a record of a laboratory session that can be used like a laboratory notebook to show information such as invention conception. Plus, the records can be fully searchable.

Squawk section 1008 includes a summary section 1020 that displays a summary of each squawk made during a laboratory session with a squawk identification 1022 and a squawk title field 1023. Squawk section 1008 also provides the ability to edit a squawk by electing edit button 1026 or delete a squawk by selecting squawk delete button 1028. As discussed previously, a squawk can be any comment that concerns the usability of laboratory equipment or issues found for the product under test.

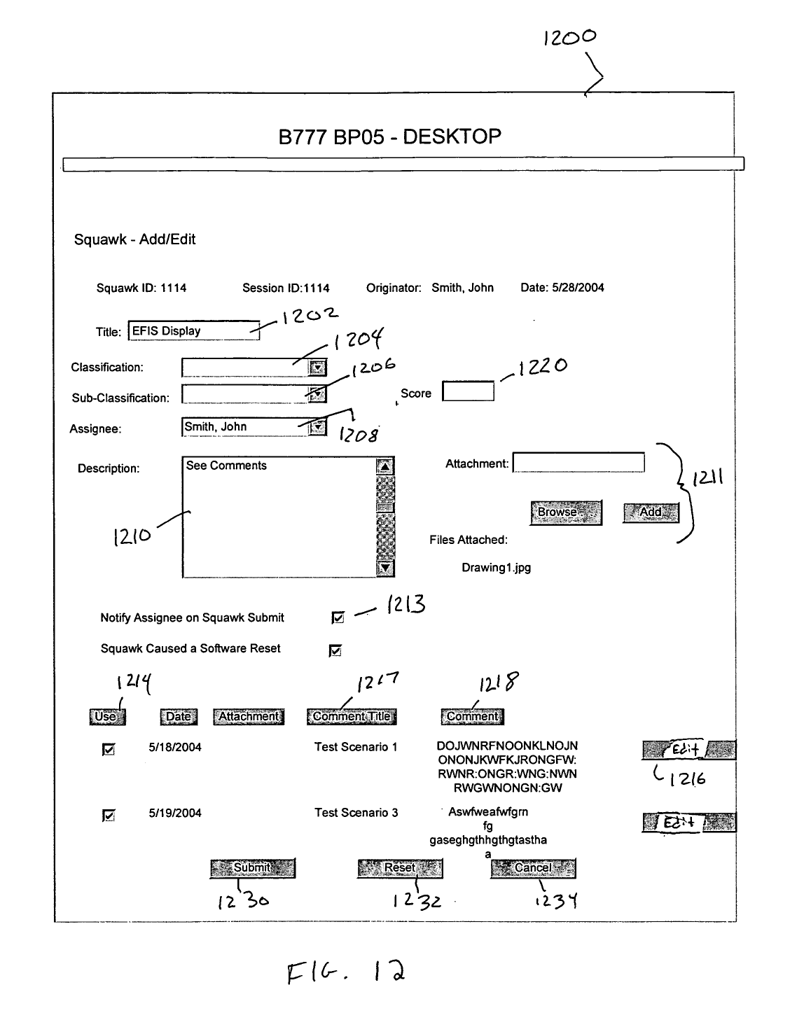

To generate a squawk, the add squawk button 1024 can be selected. This will call a squawk add/edit/view page 1200 as seen in FIG. 12. The squawk add/edit/view page 1200 allows a user to enter a squawk title in a title field 1202, a classification in a classification field 1204, a subclassification in subclassification field 1206 and an assignee 1208. The classification and sub-classification of a squawk are typically predetermined based on the set-up performed by the admin function 504, and are used to identify and organize various squawks. The assignee is an individual that is responsible for initial handling of a particular squawk and can be assigned based on the laboratory used the classification of the squawk or any other criteria. The assignee can be notified each time a squawk is generated, for example, by email. The option to notify the assignee upon generation of a squawk can be set using notify checkbox 1213.

Similar to the comment page 1000, the squawk page 1200 allows users to enter a squawk description in a description box 1210. The user can attach pertinent attachments to the squawk description through the use of attachment section 1211. Also if the user has previously entered a comment as seen in laboratory comment section 1006 of new session page 1000 that described the squawk, the user can select a comment from comment section 1212 by checking, in one embodiment, a box in use field 1214. Comment section 1212 can also include a comment title field 1217, a comment summary field 1218 listing the comment and a comment edit button 1216 that allows a comment to be edited. This utilizes the previously existing comment as the squawk information and saves on the entry of data.

The squawk page 1200 can also include a squawk score box 1220. As mentioned previously, the “health” of each bench in a laboratory is tracked. One criterion that can be used to determine the health of a bench is the score of squawks that are pending at that bench. The squawk can be given a default score that can be adjusted by the user given criteria for squawk scores or based on the user's subjective valuation of the score. These scores are used to set thresholds for transitioning the color of the Bench Health indicator in FIG. 6, box 610. In one embodiment, a squawk, which is assigned a score beyond the threshold score of “yellow” bench health, will cause the Bench Health color to transition from Green to Yellow. Further, this new squawk title can be made available to the user, in one embodiment, in a box that displays when the user moves the computer cursor over box 610. Squawk box pages 1200 also includes a submit button 1230 to submit entries, a reset button 1232 the reset entries and a cancel button 1234 to cancel entries and return to a previous screen.

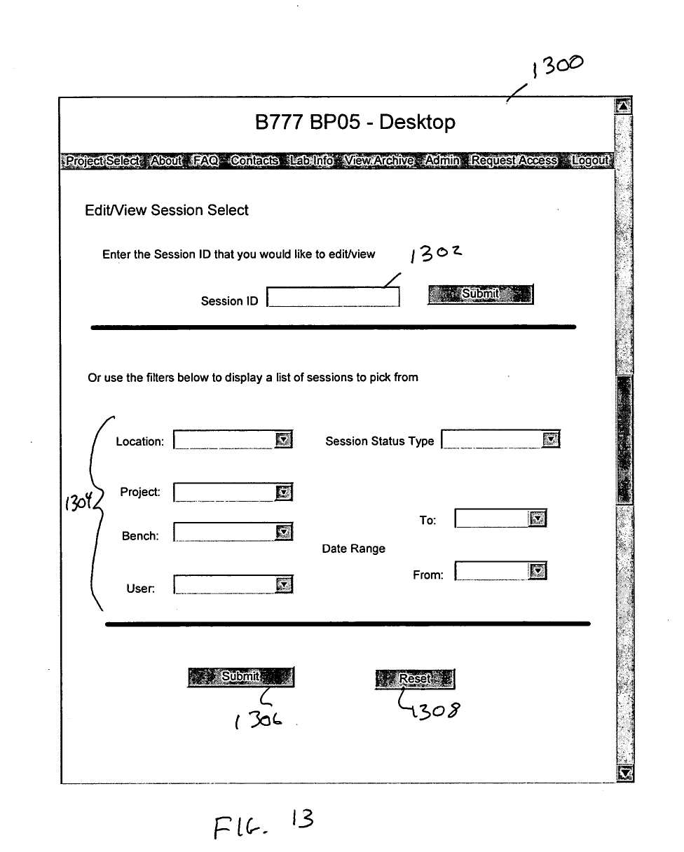

Turning back to FIG. 6, selection of the edit/view session selection 632 calls an edit/view page 1300 as seen in FIG. 13. The edit/view page 1300 allows the user to search for a session using either the session ID number (box 1302), or a search query (in search section 1304) based on filtering information such as project, bench used, user and the like. The query can be initiated by selecting submit button 1306. The query can be reset by selecting reset button 1308.

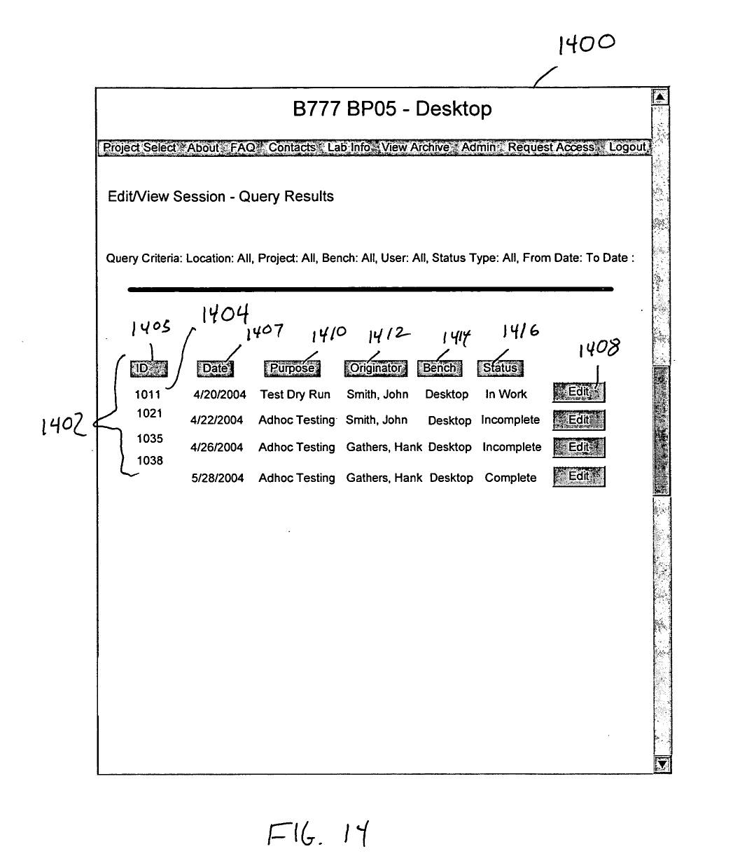

After a search is initiated and completed, a query results page 1400 as seen in FIG. 14 can be called. The query results page 1400 includes a result section 1402 listing any sessions 1404 that meet the search criteria. Typically, each search result will have an associated view button 1406, which, when selected, allows the user to view, but not change the information from that session. Typically, any user authorized to work for a given project can view previous sessions concerning the project. In certain situations, for example if the user was the originator of the session or was given rights to the session either by the originator of the session or by virtue of having administrative privileges, an edit button 1408 is provided. The edit button 1408 calls up an editable summary of the session and allows the properly authenticated user the opportunity to modify session information. The search results, in one embodiment, includes information entries in the session ID field 1405, a date field 1407, a purpose field 1410 listing the purpose of the testing (preliminary testing, verification of previous testing, and the like) and an originator field 1412 listing the originator of the comment, a bench field 1414 and a status field 1416.

Turning back to FIG. 6, selection of the laboratory help selection 634 calls up stored help information regarding the equipment at the bench or laboratory, the contact personnel for the laboratory and the like.

Selection of the laboratory squawk selection 636 calls up the squawk search page 1500. Squawk search page 1500 allows for the searching of squawks based on a squawk identification number (ID box 1502) or by a search criteria (search section 1504) using filtering information such as a keyword, session number, project name, bench, the disposition of the squawk (open, in progress, completed), the classification and/or subclassification of the squawk, the assignee or originator of the squawk and or date criteria. In situations where the user is searching based on a project name, the user can further search by disposition rationale, where the squawk disposition rationale is the reasoning behind the status of the squawk. Status of a squawk is what state the squawk is in, such as open (squawk made, not resolved), in progress (squawk in process of being resolved) or completed (resolved).

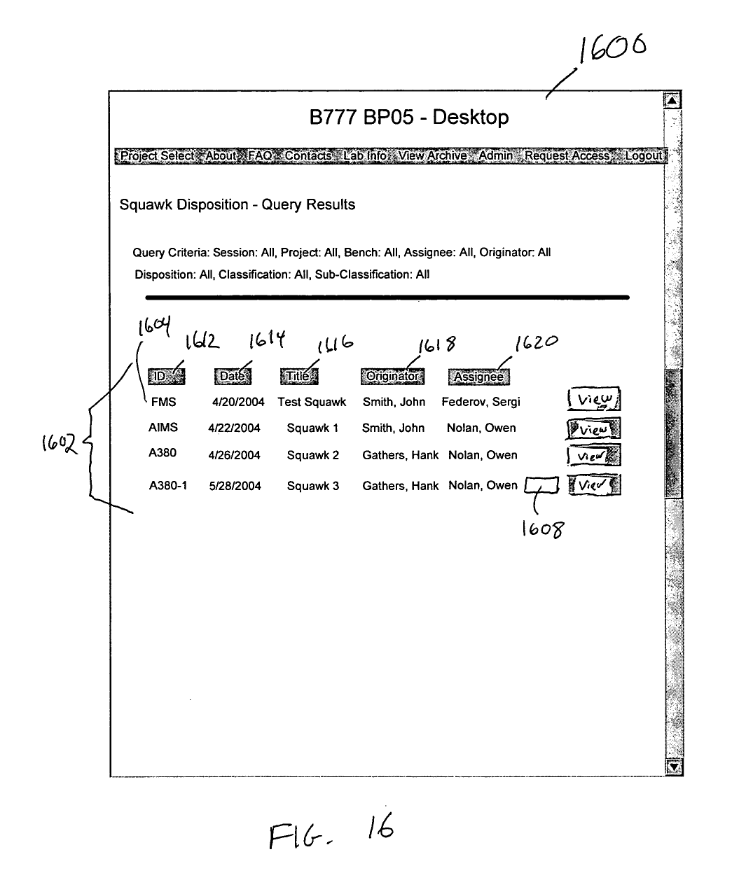

Upon submission of search criteria (initiated by selecting the submit button 1506, the fields can be reset by selecting reset button 1508) and completion of the search, a squawk search results page 1600 as seen in FIG. 16 is called. Squawk search results page 1600 includes a listing 1602 of all the squawks matching the search criteria. Each squawk 1604 has an associated view button 1606. Selection of the view button 1606 allows the user to view detailed information regarding the squawk. In certain situations, such as when the user is also an assignee of a squawk, a resolve button 1608 will also be provided. Selection of the resolve button 1608 allows the user to view and edit the information regarding a squawk in order to resolve the squawk. Information about the squawk can include a squawk identification 1612, a squawk date 1614, a squawk title field 1616, a squawk a squawk originator field 1618 and a squawk assignee field 1620.

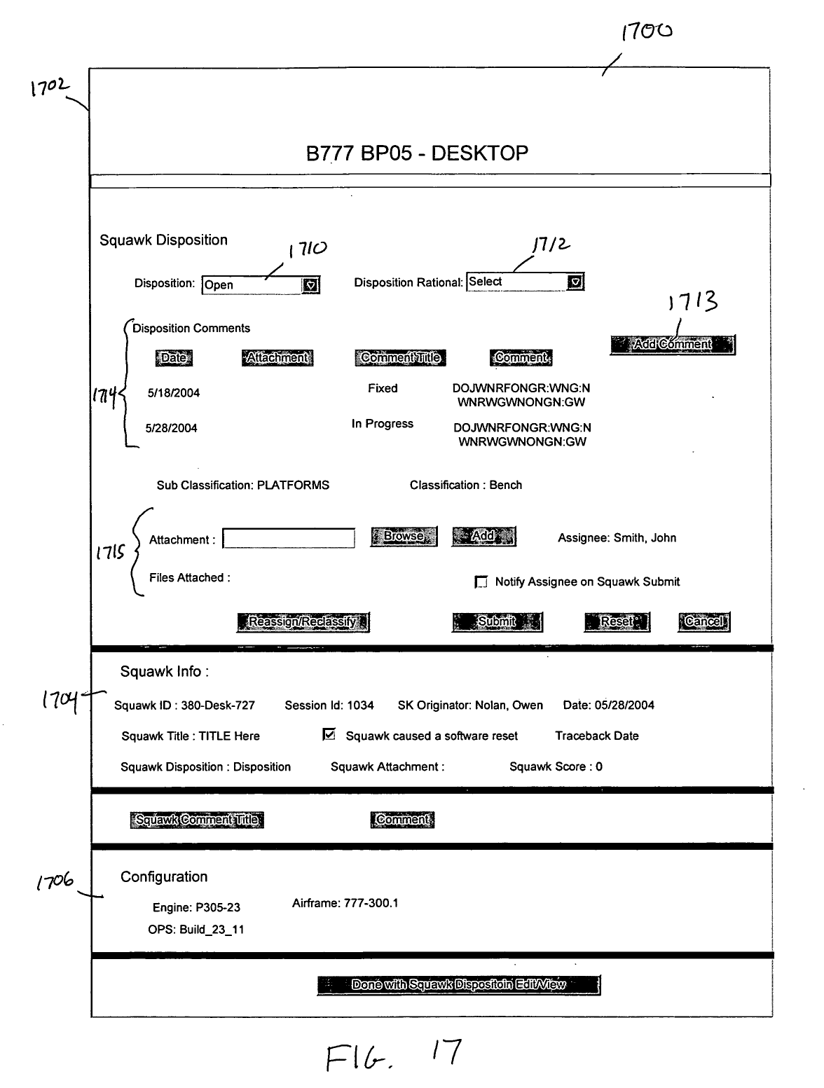

Selection of either the view button 1606 or the resolve button 1608 calls squawk summary page 1700 as seen in FIG. 17. The difference between selecting the view button 1606 or the resolve button 1608 is that selecting the resolve button 1608 allows the user to dispose of the squawk, make comments about the squawk and perform any other editing function. Selecting the view button 1606 allows the user the ability to view the squawk box but not make any changes. In the exemplary squawk summary page 1700, there is a squawk disposition section 1702, a squawk information 1704 section and a squawk configuration section 1706.

Squawk configuration section 1706 provides the configuration for the bench and or laboratory at the time the squawk was generated. The squawk information section 1704 provides a summary of the squawk including such information as the inventor identification. The squawk disposition section 1702 includes a status field 1710 that allows the user to select or enter the status of the squawk. For example, when the squawk is resolved, the user can chose or enter “completed” in the disposition field. Squawks are typically resolved by the assignee assigned to the squawk. Also included is a squawk disposition rational field 1712 that allows a user to give the reasoning behind the change in status of the squawk. Comments concerning the disposition of the squawk can be entered and viewed at a comment section 1714. By selecting add comment button 1713 comments can be made or comments can be edited.

The comment section 1714 tracks comments regarding the disposition of the squawk and dates the comments. Files supporting the comments or resolution of the squawk can be uploaded and attached to the disposition using attachment section 1715. When editing and viewing is complete, the project home page 600 can be displayed.

Turning back to FIG. 6, selection of the administrative submenu calls up an administrative page allowing a user, if the user has sufficient privileges, to perform administrative tasks.

Turning back to FIG. 6, selection of the administrative selection 636 produces a submenu 1802, as seen in FIG. 18. Submenu 1802 includes selections that allow the user, given sufficient privileges, to perform as assortment of administrative tasks. In the exemplary submenu 1802, selections include a location administration selection 1804, a user administration selection 1806, a bench administration selection 1808, an edit bench selection 1810, a project administration selection 1812 and a change password selection 1814.

Typically, while multiple menu items are shown in submenu 1802, a typical user will only see the selections to which the user has the proper access privileges. In one embodiment, responsibilities for the various administrative tasks are divided amongst different administrators. For example, there can be a super administrator who has access to all users, a location administrator in charge of adding and editing locations, a bench administrator in charge of adding and editing benches, a project administrator in charge of administrative tasks regarding projects and individual users, all of whom may have different or overlapping roles.

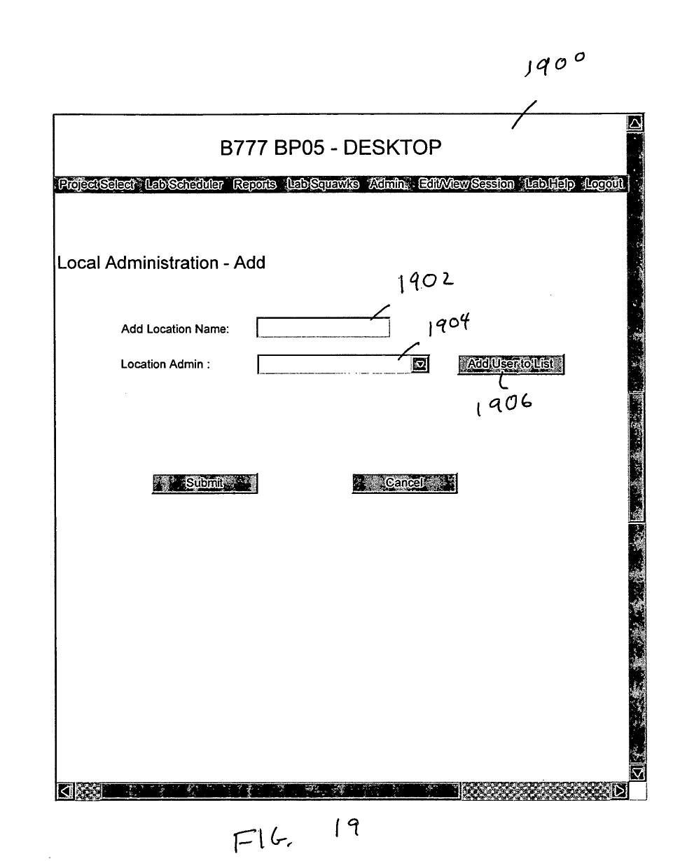

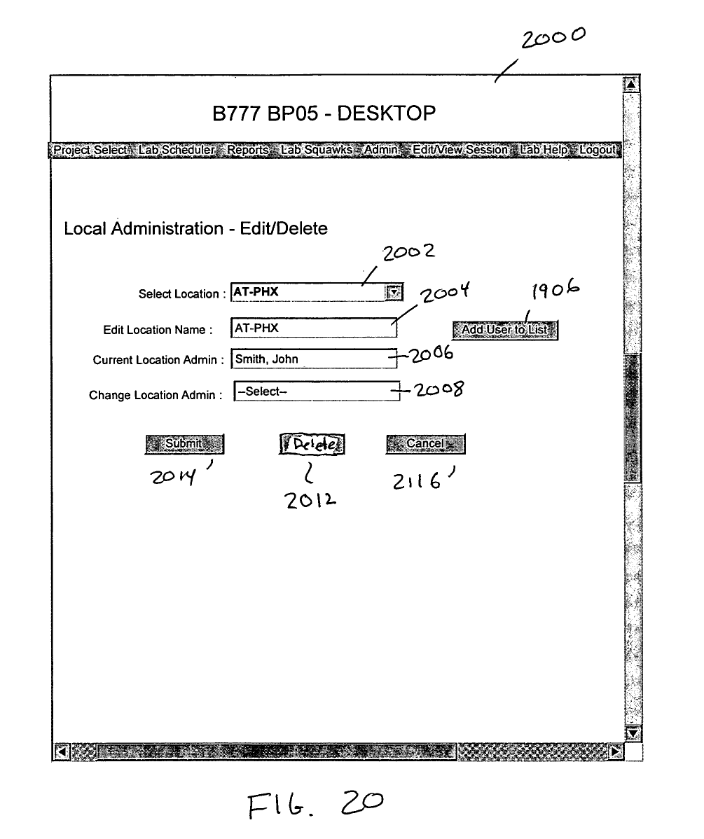

Turning back to administrative submenu 1802, selection of the location administration selection 1804 provides the user with the ability to change information regarding a location, add a location and delete locations. For example, selection of location administration selection 1804 can call up an add location screen 1900 as seen in FIG. 19 or an edit location screen 2000 as seen in FIG. 20.

The add location screen 1900 includes an add location name entry box 1902 where the name of the new location can be entered. Additionally, the administrator of the new location can be selected via location administrator box 1904. The users for the new location can be added after selection of add user to list box 1906. Entries can be submitted by selecting submit button 1906 or entries can be cancelled by selecting cancel button 1908.

The edit location screen 2000 provides the properly authenticated user the ability to edit the name and administrator of a given location. As seen in exemplary edit location screen 2000, a location name to be edited can be selected from select location box 2002. Once a current location is selected, the current administrator for that location is shown in current administrator box 2006. The administrator can be changed using administrator change box 2008. The name of the location can be edited using edit location name box 2004. By selecting the delete location box 2012, the location selected in select location box 2002 can be deleted. The change can be submitted by selecting submit button 2014. Edits can be cancelled by selecting cancel button 2016. Also, as previously shown in FIG. 19, the add user box 1906 allows the user to add or remove users to a location list.

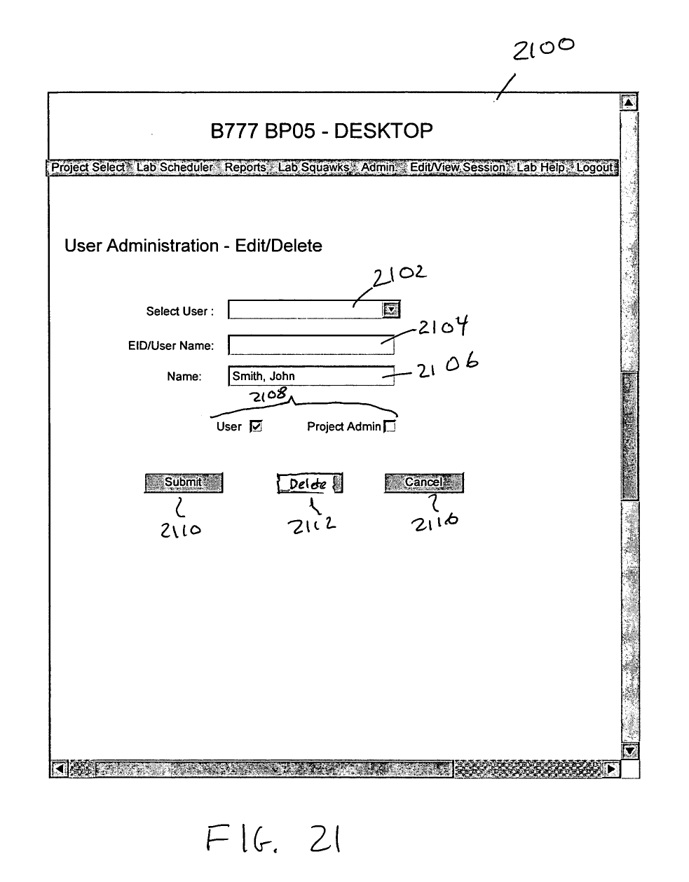

Selection of user administration selection 1806 provides the properly authenticated user the ability to add, edit or delete users. In one embodiment, selection of user administration 1806 calls user administration page 2100 as seen in FIG. 21. The user to edit or delete can be selected via select user box 2102 or by entering an employee identification number or user name in employee identification box 2104 and a name of a user in the user name box 2106. The role of the user can be selected by checking the appropriate role in the select user role section 2108. The user can be deleted by selection of the delete user box 2112. The new user or edited user can be entered into the system by selecting submit button 2110. The process can be cancelled by selecting cancel button 2116.

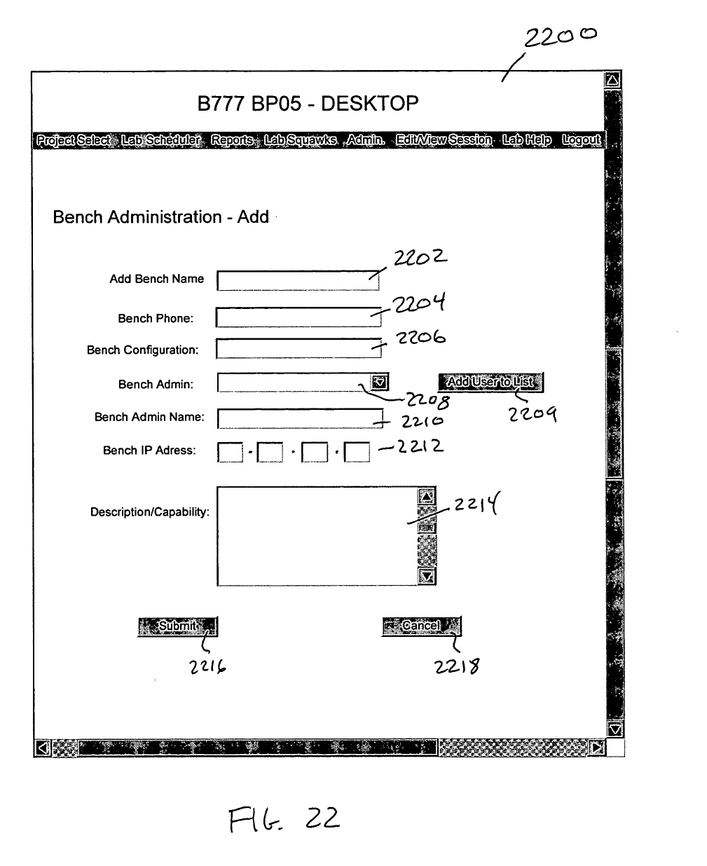

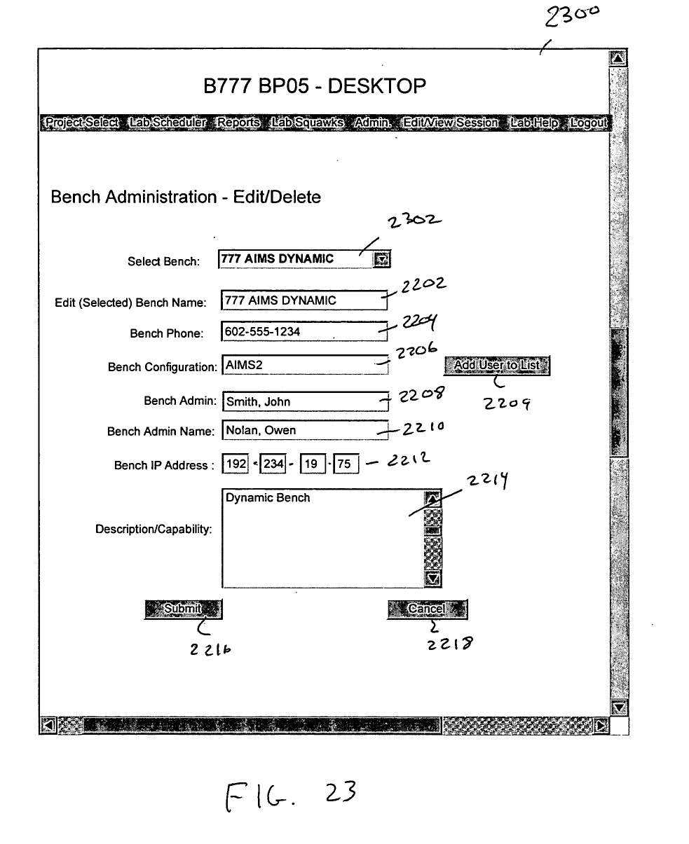

Selecting bench administration section 1808 provides the properly authenticated user with the ability to add benches to other benches available and, edit and delete existing benches. In one embodiment selection of bench administration section 1808 calls up add bench screen 2200 as seen in FIG. 22 or edit/delete bench screen 2300 as seen in FIG. 23 depending on which activity is desired by the user.

Add bench screen 2200 allows a user to add a bench and associated information by using add name box 2202, bench phone number box 2204, bench configuration box 2206, bench administrator box 2208, bench IP address 2212 and bench description box 2214 to enter the name of the bench, phone number of the bench, the physical configuration of the bench, the name of the bench administrator, the IP address of the bench computer and the description of the bench. The IP address information allows the management system to automatically detect the location from where the user is logging in to the tool, such as at a bench or a desktop. The information regarding a bench can be added by clicking on submitting button 2216. Entries can be cancelled by selecting cancel button 2218.

Edit/delete bench screen 2300 allows the user to edit the bench information. The bench information is the same as in FIG. 22. The only difference is that once the name of the bench is selected in the select bench box 2302, the other information regarding the bench can be populated with correct information that can then be edited.

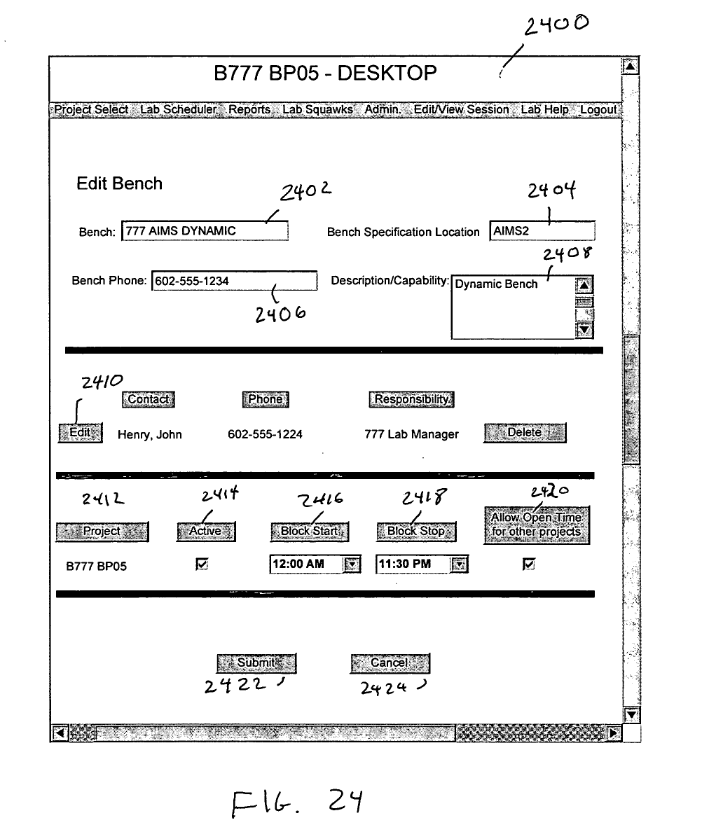

Selection of edit bench selection 1810 allows the properly authenticated user to not only edit bench information such as the information changeable from edit/delete bench screen 2300, but also to edit information about project information. Consider FIG. 24, edit bench screen 2400 includes an edit bench box 2402 for selecting the bench to edit, an edit bench location box 2404 for entering the location of the bench, an edit bench phone number box 2406 and an edit bench description box 2408 for listing the capabilities and descriptions of a bench. These boxes allow information about the bench to be changed. Also included is an edit administrator section 2410 that allows the information concerning the administrator to be changed. Edit bench screen 2400 also includes an edit project section 2412 that allows a user to indicate if the project is active (active box 2414) and to edit the start time (box 2416) and end time (box 2418) reserved for the project. The user can also indicate if open time for the project can be allocated to another user (open time box 2420). Any change can be submitted by selecting submit button 2422 or cancelled by selecting cancel button 2424.

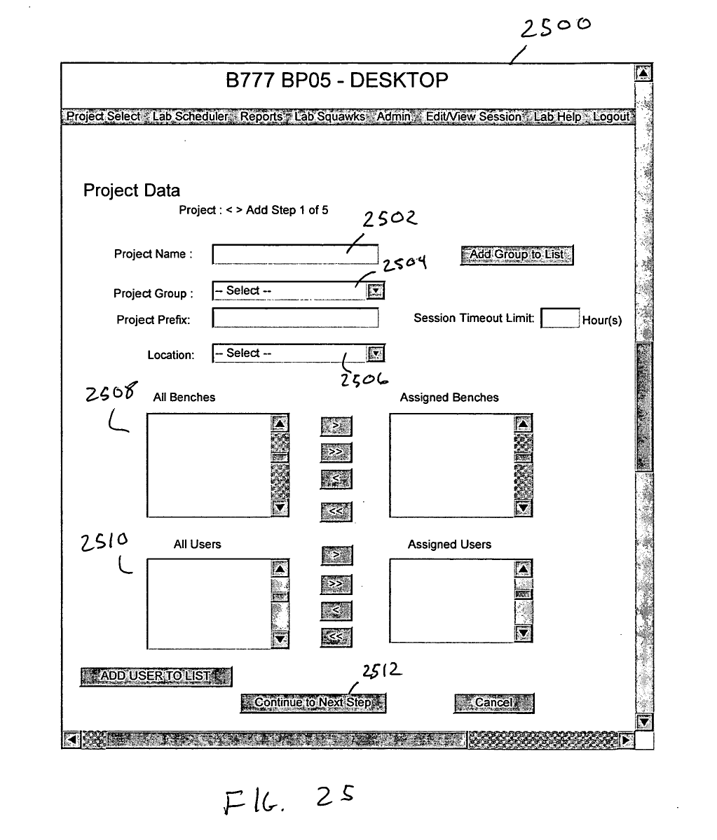

Selection of project administration selection 1812 allows a properly authenticated user to add/edit or archive or copy projects and project information. In one embodiment, information such as project data, laboratory data, squawk data, schedule data and configuration data can be added/edited or archived or copied. For example, when selecting project administration selection 1812 for adding or editing project data, a project data screen 2500, as seen in FIG. 25, can be displayed. Using this screen a project can be named (project name box 2502), a project group selected (project group box 2504), a location entered (project location box 2506), benches assigned (bench assignment section 2508) and users added to a project (user assignment section 2510). The project data screen 2500 can be either used to add project data or edit project data. Continue to next step button 2512 brings up the next project administrator page.

As part of project administration, laboratory data can also be added or edited. Laboratory data screen 2600 has a section for entering laboratory purpose (laboratory purpose box 2602) and assigning priorities for the laboratory use (priority box 2604). In one embodiment, the priority is chosen from a list in priority box 2606. The priority can be used to assign laboratories and benches after a user makes a request. A reason for lost time in the laboratory can be entered in reason box 2608. The reason for lost time can later be used by a user of a laboratory to indicator what problems in the laboratory lead to wasted time. In one embodiment the reasons chosen can be chosen from reason box 2610. Once that step is complete, the user can select the continue to next step button 2612.

The next step sets up squawk information. Squawk data page 2700 includes an assignee section 2702 that allows a user to enter a classification for a squawk (classification box 2704) and then assign the person responsible for that squawk classification (assignee box 2706). In one embodiment the name of an assignee can be selected from a list (box 2708) of eligible assignees. Also included on squawk data page 2700 is an entry for the squawk disposition rational (rational box 2709) this allows the user to enter different disposition rational. The rational appears on squawk summary page 1700. A squawk guide line can be entered (squawk guideline box 2712). A squawk guideline is a suggestion for the user to follow while considering the assignment of a squawk score. The recommended score for a squawk can be entered using recommended score box 2714. Recall that the score of squawks is one determining factor in assigning the health of a bench. Continue to next step button 2716 brings up the next project administrator page.

Continuing to the next part of the project administration, schedule data section page 2800 as seen in FIG. 28. Through this page, a user can edit the information used to schedule laboratory time. For example, the open schedule days can be set (open schedule box 2802), the request schedule limit can be set (request limit box 2804). Setting the request schedule limits sets how far in the future the request time will extend. The frequency that the requests can be processed is set in request process box 2806. Continue to next step button 2809 brings up the next project administrator page.

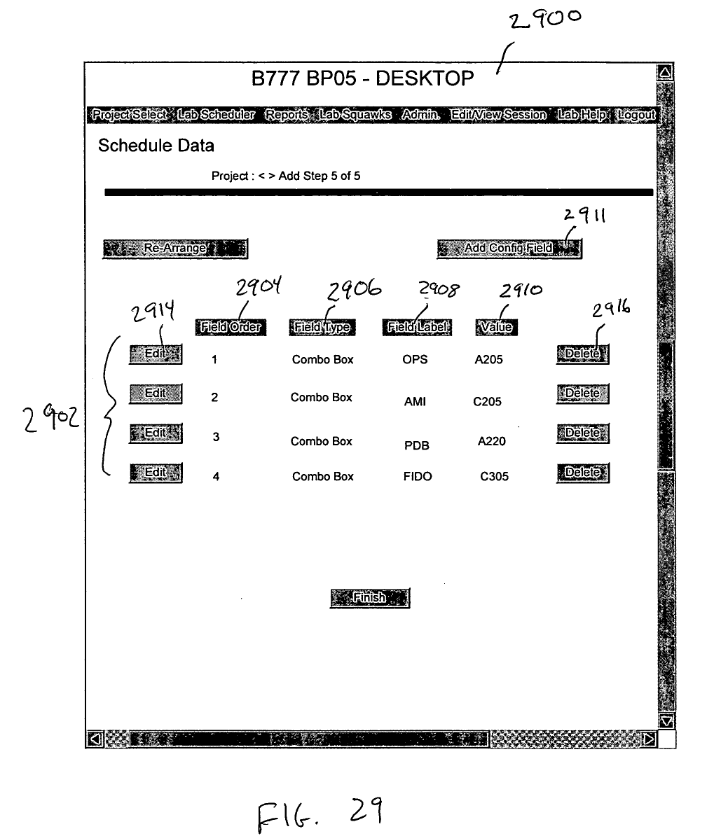

The final add project screen can be used for adding and editing configuration data. Configuration data page 2900 can be seen in FIG. 29. This screen allows a user to enter and edit configuration parameters for a project. For example data such as the aircraft being evaluated, the ending of the aircraft, the serial number of various computers and the like. These configurations appear, for example on new session screen 1000 in configuration section 1002. Configuration data page includes a configuration list 2902 listing all the different configurations. The configuration listing can include a field order (2904) that defines the order in which different configuration fields are displayed in the configuration section 1004 of FIG. 10. Also, a field type (2906) is listed. The field type indicator of the configuration for that field can be printed, in one embodiment, as text, a list box, a combo box, a radio button or a check box. These are only examples of how the information can be displayed. Also included is a field label (2908) listing the name of the field and the listing of field values (2910). Each configuration data can be edited (by selecting edit button 2914) or deleted (by selecting delete button 2916). Additional configuration items can also be added by selecting add configuration field button 2911. This will provide the user the opportunity to list more information regarding the configuration data.

Also included under the project administration menu selection 1812 are choices to copy a project, process user requests, assign limited project administrator access and reassign a project administrator rights.

Copying a project allows the authorized user to select a pre-existing project and copy all the data, such as the data discussed in conjunction with FIGS. 25-29, to a new project. Then, the user can edit any part of the project information. The ability to copy a project provides a user the ability to quickly define new projects without having to reenter data that is common with another project.

The project administrator selection 1812 provides the project administrator the ability to review user requests for access to a project. If the project administrator decides to grant the request for access, the individual requesting access can be added to the list of approved individuals for the project.

The option of limited a project administrator access allows the project administrator to grant limited project administration rights to another member of the same project. This allows users in a project to share administrative burdens.

The option to reassign project administrator rights allows a project administrator to abdicate his or her administrative rights and transfer those rights to another user.

Selection of the logout submenu logs the user out of the management system and calls the login page.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for managing the use of one or more laboratories where each laboratory comprises one or more workbenches used by a plurality of users, the method comprising:
receiving one or more requests for use of one of the workbenches;
assigning the requested workbenches based on project task priority;
receiving project data regarding a project being conducted on the workbench; the project data including comments entered by the user of the workbench; and
storing the project data.

2. The method of claim 1 wherein the step of receiving one or more requests further comprises:
presenting a screen displaying a request calendar to the user, the request calendar comprising a plurality of request boxes corresponding to a time period and date; and
receiving selection of one or more request boxes, each selected request box representing a requested time period and date.

3. The method of claim 2 wherein the step of presenting a screen further comprises presenting a screen displaying a request calendar to the user, the request calendar comprising a plurality of color coded request boxes corresponding to a time period and date, each color representing the reservation status of the workbench.

4. The method of claim 1 wherein the step of receiving project data further comprises:
receiving comments regarding the project from inputs to a project session screen.

5. The method of claim 4 wherein the step of receiving comments regarding project data further comprises receiving files associated with the project data.

6. The method of claim 1 further comprising the step of receiving information regarding problems associated with the workbench.

7. The method of claim 6 further comprising:
assigning a value for each reported problem for each workbench; and
sending an indicator of the status of each workbench based on the values of each reported problem for each workbench.

8. The method of claim 6 further comprising sending a notification to a predetermined individual upon receipt of notification of a problem.

9. The method of claim 8 further comprising sending the notification via electronic mail.

10. The method of claim 1 further comprising:
receiving a search query regarding one or more projects; and
sending the results of the search query.

11. The method of claim 10 further comprising:
receiving edited data regarding one or more of the results of the search query if the user conducting the search has authority to edit data.

12. The method of claim 6 further comprising:
receiving a search query regarding one or more problems associated with one or more workbenches; and
sending the results of the search query.

13. The method of claim 7 wherein the step of sending an indicator of the status of each workbench further comprises displaying a color-coded indicator of the status of each workbench.

14. The method of claim 1 further comprising adding a new project to one of the workbenches, the new project added by an authorized administrator.

15. The method of claim 1 further comprising:
copying the data for an existing project, the copying of the project performed by an authorized administrator; and
saving the copied project as a new project.

16. The method of claim 1 further comprising:
assigning at least one of the plurality of users of the project administrative privileges; and
allowing the user assigned privileges the ability to delegate administrative tasks.

17. A system for managing the use of one or more laboratories where each laboratory comprises one or more workbenches used by a plurality of users comprising
a server operable to:
receive one or more requests for use of one of the workbenches;
assign the requested workbenches based on project task priority;
receive project data regarding a project being conducted on the workbench; the project data including comments entered by the user of the workbench; and
a database operable to store the project data.

18. The system of claim 17 wherein the server is further operable to:
present a screen displaying a request calendar to the user, the request calendar comprising a plurality of request boxes corresponding to a time period and date; and
receive selection of one or more request boxes, each selected request box representing a requested time period and date.

19. The system of claim 18 wherein the server is further operable to present a screen displaying a request calendar to the user, the request calendar comprising a plurality of color coded request boxes corresponding to a time period and date, each color representing the reservation status of the workbench.

20. The system of claim 17 wherein the server is further operable to receive comments regarding the project from inputs to a project session screen.

21. The system of claim 20 wherein the server is further operable to receive files associated with the project data.

22. The system of claim 17 wherein the server is further operable to receive information regarding problems associated with the workbench.

23. The system of claim 22 wherein the server is further operable to:
assign a value for each reported problem for each workbench; and
send an indicator of the status of each workbench based on the values of each reported problem for each workbench.

24. The system of claim 22 wherein the server is further operable to send a notification to a predetermined individual upon receipt of notification of a problem.

25. The system of claim 24 wherein the notification is electronic mail message.

26. The system of claim 17 wherein the server is further operable to:
receive a search query regarding one or more projects; and
send the results of the search query.

27. The system of claim 26 wherein the server is further operable to:
receive edited data regarding one or more of the results of the search query if the user conducting the search has authority to edit data.

28. The system of claim 22 wherein the server is further operable to:
receive a search query regarding one or more problems associated with one or more workbenches; and
send the results of the search query.

29. The system of claim 23 wherein the indicator is a color-coded indicator of the status of each workbench.

30. The system of claim 17 wherein the server is further operable to receive a new project for one of the workbenches, the new project submitted by an authorized administrator.

31. The system of claim 30 wherein the new project comprises data copied from an existing project.

32. The system of claim 30 wherein the authorized administrator can delegate administrative tasks.

33. A system for managing the use of one or more laboratories where each laboratory comprises one or more workbenches used by a plurality of users comprising
a client computer operable to:
send one or more requests for use of one of the workbenches;
receive an assignment to the workbench, the assignment based on project task priority;
send project data regarding a project being conducted on the workbench, the project data including comments entered by the user of the workbench.

34. The system of claim 33 wherein the client computer is further operable to send a selection of one or more request boxes, from a plurality of request boxes forming a scheduling calendar and wherein each request box represents a date and time of desired laboratory use.

35. The system of claim 34 wherein the client computer displays a request calendar to the user, the request calendar comprising a plurality of color coded request boxes corresponding to a time period and date, each color representing the reservation status of the workbench.

36. The system of claim 33 wherein the client computer is further operable to send comments regarding the project from inputs to a project session screen.

37. The system of claim 33 wherein the client computer is further operable to send files associated with the project data.

38. The system of claim 33 wherein the client is further operable to:
send a search query regarding one or more projects; and
receive the results of the search query.

39. The system of claim 38 wherein the server is further operable to send edited data regarding one or more of the results of the search query if the user conducting the search has authority to edit data.

40. The system of claim 33 wherein the client computer is further operable to:
send a search query regarding one or more problems associated with one or more workbenches; and
receive the results of the search query.

41. A computer operated asset management system comprising:
a scheduling module for scheduling asset use; and
a capture and disposition module operable to allow information regarding an asset to be stored.

42. The system of claim 41 wherein the scheduling module displays time as open time, request time and blocked time.

43. The system of claim 42 wherein the request time is time requested by one or more users and allocated to each of the users based on need.

44. A computer program product, tangibly stored on a computer-readable medium, for managing the use of one or more laboratories where each laboratory comprises one or more workbenches by a plurality of users, the product comprising instructions operable to:
receive at a server one or more requests for use of one of the workbenches from a client computer;
assign the requested workbenches based on project task priority; and
receive project data from the client regarding a project being conducted on the workbench; the project data including comments entered by the user of the workbench.
